(19) United States
(12) Patent Application Publication
(10) Pub. No.: US 2025/0021201 A1
(43) Pub. Date: Jan. 16, 2025

(54) INFORMATION DISPLAY METHOD AND APPARATUS, DEVICE AND MEDIUM

(71) Applicant: Beijing Bytedance Network Technology Co., Ltd., Beijing (CN)

(72) Inventors: Huayong DING, Beijing (CN); Guiyan WANG, Beijing (CN); Wenbo WANG, Beijing (CN)

(21) Appl. No.: 18/711,837

(22) PCT Filed: Dec. 22, 2022
(86) PCT No.: PCT/CN2022/140937

§ 371 Date: May 20, 2024

(30) Foreign Application Priority Data
Jan. 21, 2022 (CN) 202210072716.7

(51) Int. Cl. G06F 3/0481; G06F 3/0484

(52) U.S. Cl. CPC G06F 3/0481; G06F 3/0484; G06F 2203/04806

(57) ABSTRACT

An information display method, apparatus, device, and medium includes: displaying at least two information cards on an information flow page; obtaining detail information of a target information card of the at least two information cards in response to a triggering operation on the target information card, wherein a width of the target information card is less than a width of the information flow page, a preset width is greater than the width of the target information card and less then or equal to the width of the information flow page; expanding the target information card on the information flow page and moving other adjacent information cards until the width of the target information card is equal to the preset width; and displaying the detail information in the expanded target information card, wherein the expanded target information card has a length set to a length of a full displayed detail information.

### CROSS-REFERENCE TO RELATED APPLICATIONS

The present application is based on and claims priority to CN Patent Application No. 202210072716.7 filed on Jan. 21, 2022, the disclosure of which is incorporated by reference herein in its entirety.

### TECHNICAL FIELD

The present disclosure relates to the field of information processing technology, in particular to an information display method and apparatus, a device and a medium.

### BACKGROUND

With the continuous development of applications and computer technology, more and more users browse a variety of information through applications. The application can attract a user to select the information of interest for further browsing by displaying a feed to the user.

At present, the implementation of further browsing on the basis of the feed is usually to open a new page to view the details of the triggered content.

### SUMMARY

In an embodiment of the present disclosure, an information display method is provided. The information display method comprises:
displaying at least two information cards on an information flow page;
obtaining detail information of a target information card of the at least two information cards in response to a triggering operation on the target information card, wherein a width of the target information card is less than a width of the information flow page, a preset width is greater than the width of the target information card and less than or equal to a width of the information flow page;
expanding the target information card on the information flow page and moving other information cards of the at least two information cards adjacent to the target information card until the width of the target information card is equal to the preset width; and
displaying the detail information in the expanded target information card, wherein a length of the expanded target information card is set to a length of a full displayed detail information.

In an embodiment of the present disclosure, an information display apparatus is also provided. The apparatus comprises:
a first display module configured to display at least two information cards on an information flow page;
a trigger module configured to obtain detail information of a target information card of the at least two information cards in response to a triggering operation on the target information card, wherein a width of the target information card is less than a width of the information flow page, a preset width is greater than the width of the target information card and less than or equal to a width of the information flow page;
an expanding module configured to expand the target information card on the information flow page and moving other information cards of the at least two information cards adjacent to the target information card until the width of the target information card is equal to the preset width; and
a second display module configured to display the detail information in the expanded target information card, wherein a length of the expanded target information card is set to a length of a full displayed detail information.

In an embodiment of the present disclosure, an electronic device is also provided. The electronic device comprises: a memory; and a processor coupled to the memory, wherein the processor is configured to, based on instructions stored in the memory, carry out the information display method provided according to any embodiment of the present disclosure based on instructions stored in the memory.

In an embodiment of the present disclosure, a computer-readable storage medium is also provided. The storage medium has a computer program stored thereon which is used to perform the information display method provided according to any embodiment of the present disclosure.

In an embodiment of the present disclosure, a computer program is also provided. The computer program includes: instructions that, when executed by a processor, cause the processor to perform the information display method provided according to any embodiment of the present disclosure.

### BRIEF DESCRIPTION OF THE ACCOMPANYING DRAWINGS

The above-described and other features, advantages and aspects of embodiments of the present disclosure will become more apparent in conjunction with the accompanying drawings and with reference to the following detailed description. Throughout the accompanying drawings, the same or similar reference numerals indicate the same or similar elements. It should be understood that the accompanying drawings are schematic, and the members and elements are not necessarily drawn to scale.

FIG. 1 is a flow chart of an information display method provided by an embodiment of the present disclosure;

FIG. 2 is a schematic view of an information display provided by an embodiment of the present disclosure;

FIG. 3 is a schematic view of another information display provided by an embodiment of the present disclosure;

FIG. 4 is a schematic view of a further information display provided by an embodiment of the present disclosure;

FIG. 5 is a schematic view of still another information display provided by an embodiment of the present disclosure;

FIG. 6 is a schematic view of yet another information display provided by an embodiment of the present disclosure;

FIG. 7 is a flow chart of another information display method provided by an embodiment of the present disclosure;

FIG. 8 is a schematic structural view of an information display apparatus provided by an embodiment of the present disclosure;

FIG. 9 is a schematic structural view of an electronic device provided by an embodiment of the present disclosure.

### DETAILED DESCRIPTION

The embodiments of the present disclosure will be described in more detail with reference to the accompanying drawings below. Although the accompanying drawings illustrate some embodiments of the present disclosure, it should be understood that the present disclosure may be implemented in various forms, and should not be construed as being limited to the embodiments set forth herein. Rather, these embodiments are intended for a more thorough and complete understanding of the present disclosure. It should be understood that the accompanying drawings and embodiments of the present disclosure are only for illustrative purposes, rather than for limiting the protection scope of the present disclosure.

It should be understood that the various steps recited in the method embodiments of the present disclosure may be performed according to different sequences, and/or performed in parallel. In addition, the method embodiments may include additional steps and/or omit to perform the illustrated steps. The scope of the present disclosure is not limited in this respect.

As used herein, the term “comprising” and its variants are open-ended inclusion, that is, “including but not limited to”. The term “based on” means “at least partially based on”. The term “an embodiment” means “at least one embodiment”; the term “another embodiment” means “at least one additional embodiment”; and the term “some embodiments” means “at least some embodiments”. The related definitions of other terms will be given in the following description.

It should be noted that the concepts such as “first” and “second” mentioned in the present disclosure are only used to distinguish different devices, modules or units, but not to limit the order or interdependence of functions performed by these devices, modules or units.

It should be noted that the modifications of “one” and “a plurality of” mentioned in the present disclosure are illustrative rather than restrictive, and those skilled in the art should understand that they should be understood as “one or more” unless contextually specified otherwise.

The names of messages or information exchanged between multiple devices in the embodiments of the present disclosure are only used for illustrative purposes, but not for limiting the scope of these messages or information.

At present, the implementation of further browsing on a basis of an information feed flow is usually to open a new page to view details of triggered content. This implementation may even lead to multinest of pages so that the information display is likely to be slow due to page jank, and lead to poor experience when the user returns to the information feed flow. Even if some details can be displayed on the page of the information feed flow, the displayed content is also limited, and the information cannot be comprehensively and effectively conveyed to the user, which results in a poor display effect of the information feed flow.

In order to solve the above-described problems, the present disclosure provides an information display method and apparatus, a device and a medium.

The information display method in embodiments of the present disclosure is mainly suitable for information flow display scenes, for example, preview information flow display scenes or detail information flow display scenes. The information display method provided by the embodiment of the present disclosure may be performed by an information display apparatus, wherein the device may be implemented by at least one of software and hardware, and the device may be integrated in an electronic device with a video playback function, such as a mobile phone, a PDA, a tablet computer, a notebook computer or a desktop computer.

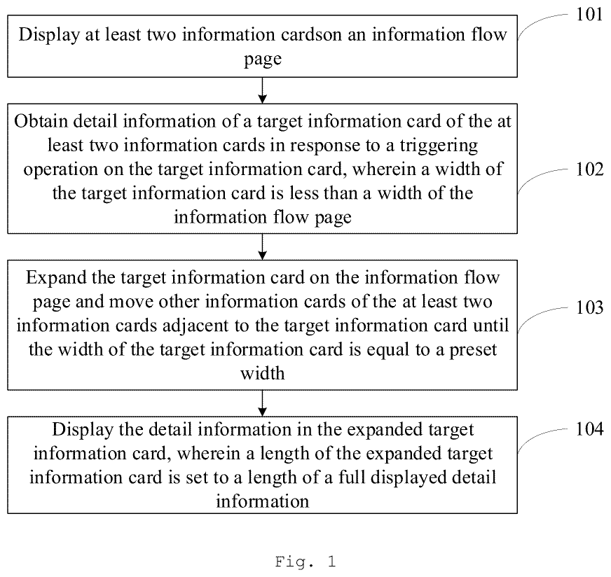

FIG. 1 is a flow chart of an information display method provided by an embodiment of the present disclosure. As shown in FIG. 1, the information display method includes the following steps.

In Step 101, at least two information cards are displayed on an information flow page.

The information flow page may be a page for displaying information flow to users in an application. In some embodiments, the information flow page may be a preview information flow page or a detail information flow page of different types of information such as video, text, or image. The information cards may be used as a method of displaying information in a form of cards, in which one information card corresponds to one item of information, and the format of the information is not limited. For example, the information may comprise a video, a text or an image. In the embodiments of the present disclosure, the size of the information card is not limited, and the sizes of different information cards may be the same or different.

Specifically, the information display apparatus may load an information flow page for presentation to the user, and the information flow page displays at least two information cards. In some embodiments, the information flow page may display at least two information cards in the form of multiple rows and multiple columns. The rows may include at least one row, and the columns may also include at least one column. The number of columns in different rows may be the same or different, and one row may display one information card, and may also display two or more information cards.

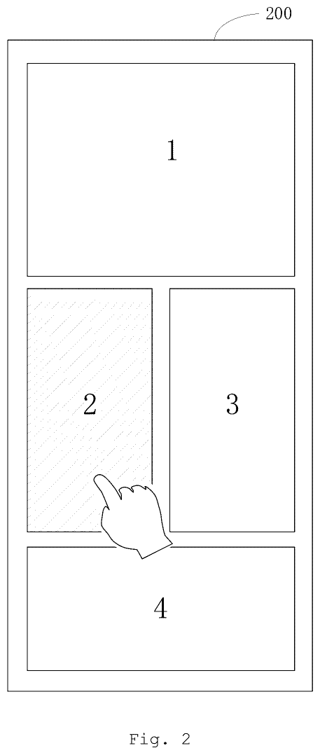

For example, FIG. 2 is a schematic view of one information display provided by an embodiment of the present disclosure. As shown in FIG. 2, an information flow page 200 is displayed, which includes four information cards with different sizes, and the second row includes two columns displaying two information cards, and the first row and the third row both display one information card. It may be understood that, the information card displayed on the information flow page shown in FIG. 2 is only an example, but not a limitation.

In Step 102, detail information of a target information card of the at least two information cards is obtained in response to a triggering operation on the target information card, wherein a width of the target information card is less than a width of the information flow page.

The target information card may be understood as the information card with a width less than that of the information flow page in the above-described at least two information cards, and the target information card is triggered by the user. The trigger operation may include a gesture control operation (for example, clicking, long press, or double clicking), a voice control operation or an expression control operation on the target information card, which is not limited in the embodiments of the present disclosure. The detail information may be complete information corresponding to the information card. For example, when the information card displays an article header, the detail information may be a full text of the article corresponding to the article header.

Specifically, after the information display apparatus displays at least two information cards on the information flow page, it is possible to detect a trigger operation by the user, and when a trigger operation of the user on the target information card is received, it is possible to obtain the detail information of the target information card from the server.

For example, referring to FIG. 2, the finger represents a trigger operation of the user, and the information card 2 is a target information card triggered by the user.

In Step 103, the target information card is expanded on the information flow page and other information cards of the at least two information cards adjacent to the target information card are moved until the width of the target information card is equal to a preset width.

The preset width is greater than the width of the target information card before expanding and less than or equal to a width of the information flow page, that is, a difference between the preset width and the width of the information flow page is smaller than a difference threshold. The difference threshold may be set according to actual conditions. For example, the difference threshold may be 2 millimeters or 10 pixels.

Specifically, after receiving a trigger operation of the user on the target information card, the information display apparatus may expand the target information card on the information flow page, that is, the size of the target information card is enlarged, and other information cards adjacent to the target information card are moved beyond the information flow page. The movement direction corresponds to the expanding direction of the target information card. For example, in response to the target information card being expanded to the right, other adjacent cards on the right of the target card may move to the right. The movement stops when the width of the target information card reaches the preset width and the length can completely display the detail information corresponding to the target information card.

In some embodiments, expanding the target information card on the information flow page may include: expanding the target information card on the information flow page based on an original position of the target information card, wherein the original position may be understood as a position of the target information card before the information flow page is expanded.

In some embodiments, the original position is determined based on an upper boundary and a target side boundary of the target information card, and the target side boundary is a side boundary of the target information card adjacent to a boundary of the information flow page; or the original position is determined based on the upper boundary of the target information card. In response to the left boundary of the target information card being adjacent to the left boundary of the information flow page, the original position may be the upper boundary and the left boundary of the target information card. In response to the right boundary of the target information card being adjacent to the right boundary of the information flow page, the original position may be the upper boundary and the right boundary of the target information card. In response to the left and right boundaries of the target information card being both at a certain distance from the boundary of the information flow page, that is, not adjacent, the original position is the upper boundary of the target information card.

Specifically, when the information display apparatus expands the target information card on the information flow page, it is possible to expand downward based on the upper boundary of the target information card; or expand downward and expand in the opposite direction to the boundary of the target side based on the upper boundary and the boundary of the target side, that is, expanding to the right when the boundary of the target side is the left boundary, and expanding to the left when the boundary of the target side is the right boundary.

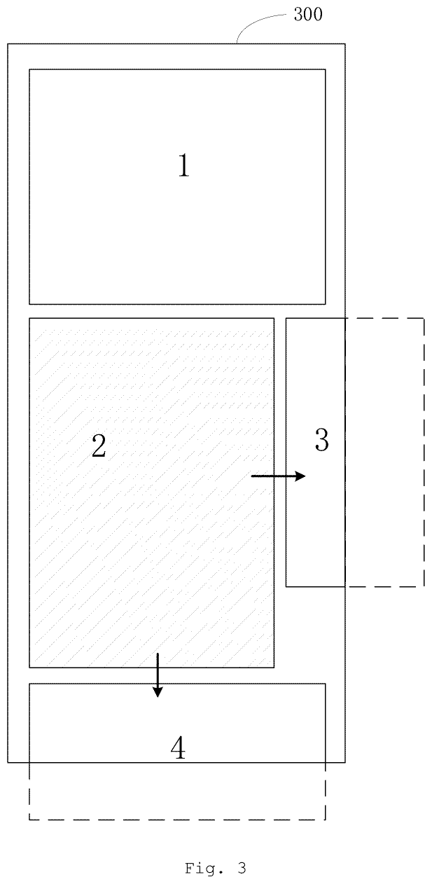

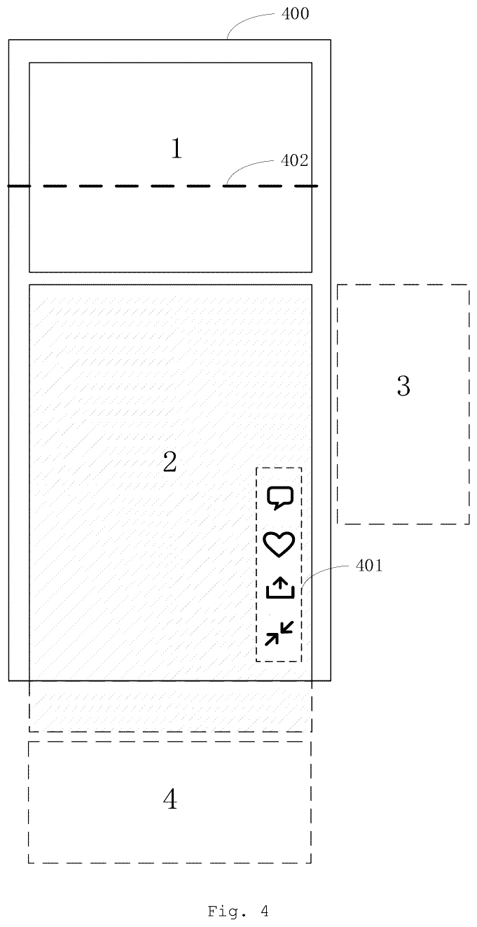

For example, FIG. 3 is a schematic view of another information display provided by an embodiment of the present disclosure, and FIG. 4 is a schematic view of a further information display provided by an embodiment of the present disclosure. The information flow page 300 in FIG. 3 and the information flow page 400 in FIG. 4 are the same information flow page as the information flow page 200 in FIG. 2. The area where the dashed box is located in FIGS. 3 and 4 indicates to be not shown on the information flow page. FIG. 3 presents the information flow page of the information card 2 in FIG. 2 during the expanding process. As shown in FIG. 3, at this time, since the left boundary of the information card 2 is adjacent to the left boundary of the information flow page 300, the original position is the left boundary and the upper boundary of the information card 2, the information card 2 expands to the right and downward, and some areas of the information cards 3 and 4 (the area where the dotted box is located) move out of the information flow page 200. FIG. 4 presents the information flow page of the information card 2 in FIG. 2 after expanding. Compared with FIG. 3, the width of the information card 2 reaches the preset width and the length can completely display the detail information. Some areas of the information card 2 are displayed in the information flow page and the dashed box area is beyond the information flow page, and all the areas of the information cards 3 and 4 are moved out of the information flow page 200. The expanding of the information cards in FIGS. 3 and 4 is only an example, and the expanded information card 2 may also be completely displayed on the information flow page in a small size (not shown).

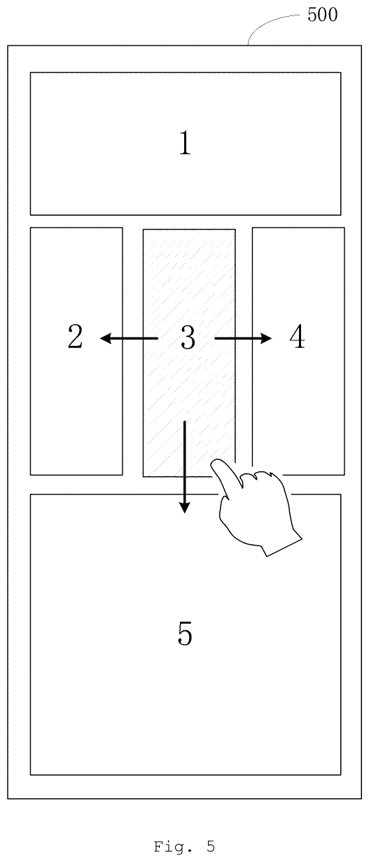

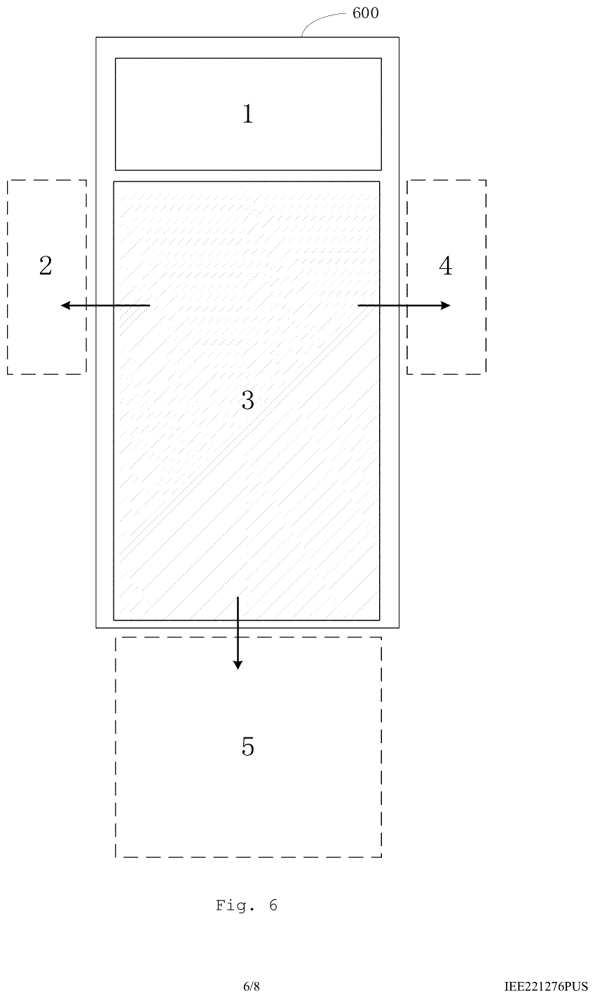

For example, FIG. 5 is a schematic view of still another information display provided by an embodiment of the present disclosure, and FIG. 6 is a schematic view of yet another information display provided by an embodiment of the present disclosure. The information flow page 500 in FIG. 5 and the information flow page 600 in FIG. 6 are the same page. As shown in FIG. 5, it presents an information flow page 500 different from the above-described information flow page 200 in FIG. 2. The information flow page 500 includes five information cards with different sizes, and the second row includes three columns displaying three information cards, and the first row and the third row both display one information card. The information card 3 in FIG. 5 is an information card triggered by the user. Since the left boundary and the right boundary of the information card 3 are not adjacent to the boundary of the information flow page, the original position is the upper boundary of the information card 3 (an example, the midpoint or a certain characteristic position point of the upper boundary of the information card 3 may serve as a reference point), so that the information card 3 expands to the left, to the right and downward, while the adjacent information card 2 moves to the left, the information card 4 moves to the right and the information card 5 moves downward. FIG. 6 presents the information flow page 600 of the information card 3 in FIG. 5 after expanding, and the area where the dashed box is located in FIG. 6 indicates to be not displayed on the information flow page. Compared with FIG. 5, the width of the information card 3 reaches the preset width so that the length can completely display the detail information. At this time, the expanded information card 3 may be completely displayed in the information flow page 600, and the information card 2, the information card 4 and the information card 5 are all moved out of the information flow page 600.

The above-described examples which respectively presents schematic views of the information card expanded in the case where the original position is the left boundary and the upper boundary of the information card and the original position is the upper boundary of the information card, are only examples, but not a limitation.

In some embodiments, the original position is a position of a center point of the target information card in the information flow page. When the information display apparatus expands the target information card on the information flow page, the center point of the target information card may be expanded to all around in unlimited directions based on the position of the center point of the target information card on the information flow page.

In the above-described solutions, after the user triggers the information card, the information card may be expanded in the original position in a plurality of methods, which improves the diversity and flexibility of expanding the information card and further improves the effect of information display.

In other embodiments, expanding the target information card on the information flow page may include: moving the target information card to a preset position and expanding the target information card on the information flow page based on the preset position. The preset position may be set according to actual needs and service needs of the user. In some embodiments, the preset position is the center position, a position of user's line of sight or a top position on the information flow page.

Specifically, when the information display apparatus expands the target information card on the information flow page, it is also possible to first move the target information card to a preset position. In response to the preset position being the center position or the position where the line of sight of the user is situated in the information flow page, it is possible to move the center point of the target information card to the preset position during movement, and expand the target information card to all around based on the preset position. In response to the preset position being the top position of the information flow page, it is possible to move the upper boundary of the target information card to the top position during movement, and then expand the target information card downward based on the preset position.

In the above-described solution, after the user triggers the information card, the information card may be moved to a fixed position and then expanded, so that the user may browse the expanded information card at an optimum position, thereby further improving the effect of information display.

In Step 104, the detail information is displayed in the expanded target information card, wherein a length of the expanded target information card is set to a length of a full displayed detail information.

After the target information card is expanded on the information flow page, the information display apparatus may display the detail information of the target information card in the expanded target information card. Then the target information card may be completely displayed on the information flow page, or only some areas may be displayed on the information flow page, specifically depending on the length of the target information card.

For example, referring to FIG. 4, some areas of the expanded information card 2 are displayed in the information flow page, and the dashed box area is beyond the information flow page.

In the information display solution provided by the embodiment of the disclosure, at least two information cards are displayed on an information flow page; detail information of a target information card of the at least two information cards is obtained in response to a triggering operation on the target information card, wherein a width of the target information card is less than a width of the information flow page, a preset width is greater than the width of the target information card and less than or equal to a width of the information flow page; the target information card is expanded on the information flow page and other information cards of the at least two information cards adjacent to the target information card are moved until the width of the target information card is equal to the preset width; and the detail information is displayed in the expanded target information card, wherein a length of the expanded target information card is set to a length of a full displayed detail information. By using the above-described technical solution, for the information card with a small width displayed on the information flow page, in response to receiving a trigger operation of the user, the information card may be expanded in the current information flow page until the width reaches the preset width, and its corresponding detail information is displayed in the expanded information card, so that the user may directly browse the detail information on the current page, which avoids poor user experience resulting from multi-level and deep nesting of the page, and the information may be conveyed to the user more simply, rapidly and comprehensively, so that the whole process is more smooth, thereby allowing for a more intense immersion of the user and improving the information browsing experience effect of the user.

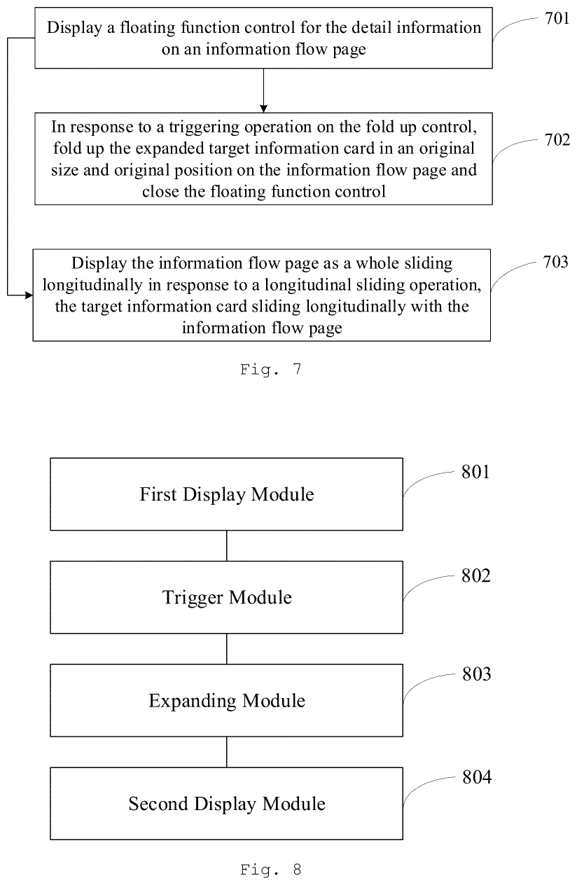

For example, FIG. 7 is a flow chart of another information display method provided by an embodiment of the present disclosure. In an alternative embodiment, after displaying the detail information in the expanded target information card, the information display method may further include the following steps.

In Step 701, a floating function control for the detail information is displayed on an information flow page.

The floating function control may be understood as a control capable of floating above the information flow page. The floating function control may include a plurality of controls with different functions. In the embodiment of the present disclosure, the floating function control may include at least one of an interactive control and a fold up control. The interactive control may be understood as a functional control for providing an interactive operation with the user, and may specifically include a plurality of controls. For example, the interactive control may include at least one of a comment control, a like control, a sharing control or a forwarding control. The fold up control may be configured to fold up the expanded target information card and close the above-described floating function control.

After the information display apparatus displays its detail information in the expanded target information card, it is possible to display the floating function control on the information flow page. The position of the floating function control is not limited, and it may be provided at any position that does not affect the display of the detail information. For example, the floating function control may be provided at the right boundary of the information flow page.

For example, referring to FIG. 4, four floating function controls are displayed in the area 401, and a comment control, a like control, a sharing control and a fold up control are sequentially displayed from top to bottom, which is only an example. More controls may be provided according to actual needs.

In Step 702, in response to a triggering operation on the fold up control, the expanded target information card is folded up in an original size and original position on the information flow page and the floating function control is closed.

After displaying the above-described floating function control, the information display apparatus may fold up the expanded target information card to the original size and the original position before expanding, that is, restoring the expanded target information card to the original size and the original position, and the floating function control is closed.

After the above-described step 701 or after the detail information is displayed in the expanded target information card, step 703 may also be performed.

In Step 703, the information flow page is displayed as a whole sliding longitudinally in response to a longitudinal sliding operation, the target information card sliding longitudinally with the information flow page.

The longitudinal sliding operation may include at least one of an upward or a downward sliding operation, which is not specifically limited.

Specifically, after receiving a longitudinal sliding operation of the user on the information flow page, the information display apparatus may display the information card displayed in the information flow page by sliding longitudinally as a whole, and the target information card also slides longitudinally there along with. For example, when the longitudinal sliding operation is an upward sliding operation, in response to the length of the target information card being long and only a part of the areas of the target information card is displayed in the information flow page, along with the target information card sliding upward, the detail information in other areas that are not displayed will be gradually displayed, so that the user may browse the detail information of the whole target information card. For example, as shown in FIG. 4, along with upward sliding of the user, some areas of the information card 2 that are not displayed will be displayed on the information flow page, and along with further sliding, the information card 4 adjacent to the lower boundary of the information card 2 and moving during the expanding process of the information card 2 and other cards adjacent to the information card 4 will be displayed. These information cards may be in an expanded state or a fold up state, depending on whether the user performs an expanding or folding up operation on the information card previously; or also depending on the processing of the card according to a preset strategy. For example, in response to the expanded information card being not displayed on the screen, it may automatically enter a fold up state. In another embodiment, in response to a downward sliding operation of the user, the information card 1 adjacent to the upper boundary of the information card 2 and other cards adjacent to the information card 1 may also be continued to be displayed. That is, after the target information card is expanded, it may remain in the original information flow, and the detail information is displayed by expanding and moving adjacent cards in the original information flow without affecting the browsing logic of the original information flow.

In some embodiments, a display position of the floating function control remains unchanged during a longitudinal sliding of the target information card, and the floating function control is closed in response to a lower boundary of the target information card slides upwardly to a first predetermined position of the information flow page or an upper boundary of the target information card slides downwardly to a second predetermined position of the information flow page.

The first preset position and the second preset position may be set and adjusted according to actual conditions. In an alternative manner, the floating function control will not slide along with a longitudinal sliding of the target information card, that is, the display position of the floating function control on the information flow page is unchanged, but will be automatically closed along with a sliding position of the target information card. In a case where the longitudinal sliding operation being an upward sliding operation, the floating function control may be closed in response to the lower boundary of the target information card sliding upward to the first preset position. In a case where the longitudinal sliding operation is a downward sliding operation, the floating function control may be closed in response to the upper boundary of the target information card sliding downward to the second preset position.

For example, referring to FIG. 4, the dotted line 402 may represent an exemplary first preset position, and in response to the lower boundary of the information card 2 sliding upward to this dotted line 402, the floating function control in the area 401 may be closed.

In some embodiments, the floating function control may be closed by a preset method. For example, the preset method may be to move to a boundary side of the nearest information flow page until it is completely moved out. Alternatively, the preset method may be closing in an original position, and different floating function controls may be closed one by one in turn or at the same time.

In the above-described solution, after displaying the detail information in the expanded information card in the information flow page, a corresponding floating function control may also be displayed, so that the user may perform various interactive operations or fold up operations on the detail information in the expanded information card without affecting normal longitudinal sliding experience, and further improving the information browsing experience effect of the user.

In some embodiments, the detail information includes an picture, and the information display method may further include performing a resizing operation on the picture in response to a triggering operation on the picture, the resizing operation comprising zooming in or zooming out.

Since the information format included in the detail information is not limited, the detail information may include an picture, and the information display apparatus may correspondingly zoom in or zoom out the picture when receiving a zoom-in trigger operation or a zoom-out trigger operation of the user on the picture, and the specific zoom-in factor or the zoom-out factor may be determined according to a trigger distance of the user.

In some embodiments, the information display method may further include: displaying the picture on the information flow page in full-screen in response to a full-screen display operation on the picture. In some embodiments, in response to the number of the images being at least two, after the images are displayed on the information flow page in full screen, the information display method may further include: switching the picture to another picture in response to a sliding operation on the current picture.

The full-screen display operation may include a gesture control operation (for example, click, long press, or double click), a voice control operation and the like, which is not specifically limited. When a full-screen display operation of the user on the image in the detail information is received, the information display apparatus may display the image in full screen. After that, in response to a left or right sliding operation of the user on the current picture being received, the current picture may be slid out along a sliding operation direction and switched to be a next picture in the detail information, and in response to the detail information only including the current picture, the switching will not be performed.

In the above-described solution, after the detail information is displayed in the expanded information card in the information flow page is expanded, operations such as zooming in, zooming out, displaying in full-screen and switching may also be performed on the picture in the detail information, so that the user may perform various operations of displaying the detail information through a new page in the related art in the displayed information card, which conforms more to actual needs of the user and further improves the effect of information display.

In this application, the information card may directly expand the detail information in the displayed page without jumping to a page, which improves the operation efficiency and the operation experience, so that the process of directly expanding the information card during the process of browsing the information flow provides a more smooth feeling and more immersion for the user. The problems of poor experience when the user returns and poor experience when some users are induced due to multi-level and deep nesting of windows are solved. Moreover, after the details are expanded, the floating function control may also be provided, so that the user may perform interactive operations such as comment, like, or sharing in the currently expanded area without hindering normal reading experience by longitudinal sliding. After the user slides beyond an expanded range, the floating function control will be automatically folded up or disappeared, which further improves the reading experience effect of the user.

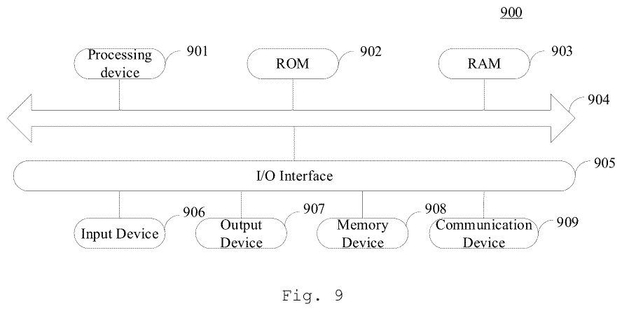

FIG. 8 is a schematic structural view of an information display apparatus provided by an embodiment of the present disclosure, which may be realized by software and/or hardware and may be generally integrated in an electronic device. As shown in FIG. 8, the apparatus includes:
a first display module 801 configured to display at least two information cards on an information flow page;
a trigger module 802 configured to obtain detail information of a target information card of the at least two information cards in response to a triggering operation on the target information card, wherein a width of the target information card is less than a width of the information flow page, a preset width is greater than the width of the target information card and less than or equal to a width of the information flow page;
an expanding module 803 configured to expand the target information card on the information flow page and move other information cards of the at least two information cards adjacent to the target information card until the width of the target information card is equal to the preset width; and
a second display module 804 configured to display the detail information in the expanded target information card, wherein a length of the expanded target information card is set to a length of a full displayed detail information.

In some embodiments, the expanding module 803 includes a first unit configured to: expand the target information card on the information flow page based on an original position of the target information card.

In some embodiments, the original position is determined based on an upper boundary and a target side boundary of the target information card, and the target side boundary is a side boundary of the target information card adjacent to a boundary of the information flow page; or the original position is determined based on the upper boundary of the target information card.

In some embodiments, the original position is a position of a center point of the target information card in the information flow page.

In some embodiments, the expanding module 803 includes a second unit configured to: move the target information card to a preset position and expanding the target information card on the information flow page based on the preset position.

In some embodiments, the preset position is a center position, a position of user's line of sight or a top position on the information flow page.

In some embodiments, the apparatus further comprises a functional module configured to: display a floating function control for the detail information after displaying the detail information in the expanded target information card, wherein the floating function control comprises at least one of an interaction control or a fold up control.

In some embodiments, the apparatus further comprises a fold up module configured to: in response to a triggering operation on the fold up control, fold up the expanded target information card in an original size and original position on the information flow page and closing the floating function control.

In some embodiments, the apparatus further comprises a longitudinal sliding module configured to, after displaying the detail information in the expanded target information card, display the information flow page as a whole sliding longitudinally in response to a longitudinal sliding operation, the target information card sliding longitudinally with the information flow page.

In some embodiments, a display position of the floating function control remains unchanged during a longitudinal sliding of the target information card; and the floating function control is closed in response to a lower boundary of the target information card slides upwardly to a first predetermined position of the information flow page or an upper boundary of the target information card slides downwardly to a second predetermined position of the information flow page.

In some embodiments, the detail information comprises a picture, and the apparatus further comprises a first image module configured to: perform a resizing operation on the picture in response to a triggering operation on the picture, the resizing operation comprising zooming in or zooming out.

In some embodiments, the apparatus further comprises a second image module configured to: display the picture in full-screen on the information flow page in response to a full-screen display operation on the picture.

In some embodiments, the detail information comprises at least two pictures, and the apparatus further comprises a third image module configured to: switch the picture to another picture in response to a sliding operation on the picture after displaying the picture in full screen on the information flow page.

In some embodiments, each information card corresponds to an item of information, which includes at least one of a video, a text or an image.

The information display apparatus provided by the embodiment of the present disclosure may perform the information display method provided by any of the embodiments of the present disclosure, and possesses corresponding functional modules to perform the method and beneficial effects.

The embodiments of the present disclosure further provide a computer program product including a computer program/instruction that, when executed by a processor implements the information display method provided by any of the embodiments of the present disclosure.

FIG. 9 is a schematic structural view of an electronic device provided by an embodiment of the present disclosure. Refer to FIG. 9, which shows a structural schematic view of an electronic device 900 suitable for implementing the embodiment of the present disclosure. The electronic device 900 in the embodiment of the present disclosure may include, but is not limited to, mobile terminals such as mobile phones, notebook computers, digital broadcast receivers, PDA (personal digital assistant), PAD (pad computer), PMP (Portable Multimedia Player) and in-vehicle terminals (for example, in-vehicle navigation terminals); and fixed terminals such as digital TVs, desktop computers and the like. The electronic device shown in FIG. 9 which is only an example, shall not limit the functions and application range of the embodiments of the present disclosure.

As shown in FIG. 9, the electronic device 900 may include a processing device (for example, a central processing unit, a graphic processor, and the like) 901, which may perform various suitable actions and processing according to a program stored in a Read-only Memory (ROM) 902 or a program loaded from a storage device 908 into a Random Access Memory (RAM) 903. In the RAM 903, various programs and data required for the operation of the electronic device 900 are also stored. The processing device 901, the ROM 902 and the RAM 903 are connected to each other through a bus 904. The input/output (I/O) interface 905 is also connected to the bus 904.

Generally, the following devices may be connected to the I/O interface 905: an input device 906 including, for example, a touch screen, a touch pad, a keyboard, a mouse, a camera, a microphone, an accelerometer, a gyroscope, and the like; an output device 907 including, for example, a Liquid Crystal Display (LCD), a speaker, a vibrator, and the like; a storage device 908 including, for example, a magnetic tape, a hard disk, and the like; and a communication device 909. The communication device 909 may allow the electronic device 900 to be in wireless or wired communication with other devices to exchange data. Although FIG. 9 shows the electronic device 900 with various devices, it should be understood that there is no requirement to implement or have all the devices shown. It is possible to alternatively implement or possess more or less devices.

In particular, according to an embodiment of the present disclosure, the process described above with reference to the flow chart may be implemented as a computer software program. For example, in an embodiment of the present disclosure, there includes a computer program product, which includes a computer program carried on a non-transient computer-readable medium, wherein the computer program contains program codes for executing the method shown in the flow chart. In such embodiment, the computer program may be downloaded and installed from the network through the communication device 909, installed from the storage device 908, or installed from the ROM 902. When the computer program is executed by the processing device 901, the above-described functions defined in the information display method in the embodiment of the present disclosure are performed.

It is to be noted that, the above-described computer-readable medium of the present disclosure may be a computer-readable signal medium, a computer-readable storage medium or any combination thereof. The computer-readable storage medium may be, for example, but is not limited to: an electrical, magnetic, optical, electromagnetic, infrared, or semiconductor system, device, or apparatus, or a combination thereof. More specific examples of the computer-readable storage medium may include, but is not limited to: an electrical connection having one or more wires, a portable computer disk, a hard disk, a random access memory (RAM), a read-only memory (ROM), an erasable programmable read-only memory (EPROM or flash memory), an optical fiber, a portable compact disk read-only memory (CD-ROM), an optical storage device, a magnetic storage device, or any suitable combination thereof. In the present disclosure, a computer-readable storage medium may be any tangible medium that contains or stores a program which may be used by an instruction execution system, apparatus, or device or used in combination therewith. In the present disclosure, the computer-readable signal medium may include a data signal propagated in a baseband or as a part of a carrier wave, wherein a computer-readable program code is carried. Such propagated data signal may take many forms, including but not limited to an electromagnetic signal, an optical signal, or any suitable combination thereof. The computer-readable signal medium may also be any computer-readable medium other than the computer-readable storage medium. The computer-readable signal medium may send, propagate, or transmit a program for use by an instruction execution system, apparatus, or device or in combination with therewith. The program code contained on the computer-readable medium may be transmitted by any suitable medium, including but not limited to: a wire, an optical cable, radio frequency (RF), and the like, or any suitable combination thereof.

In some embodiments, the client and the server may communicate using any currently known or future developed network protocol such as HTTP (HyperText Transfer Protocol), and may be interconnected with digital data communication in any form or medium (for example, communication network). Examples of communication networks include a Local Area Network (“LAN”), a Wide Area Network (“WAN”), an extranet (for example, Internet) and an end-to-end network (for example, an ad hoc end-to-end network), as well as any currently known or future developed network.

The above-described computer-readable medium may be included in the above-described electronic device; or may also exist alone without being assembled into the electronic device.

The above-described computer-readable medium carries one or more programs that, when executed by the electronic device, cause the electronic device to: display at least two information cards on an information flow page; obtain the detail information of the target information card in response to a trigger operation on a target information card in the at least two information cards, wherein the width of the target information card is less than that of the information flow page; expand the target information card on the information flow page, and move other information cards adjacent to the target information card in the at least two information cards until the width of the target information card is equal to a preset width, wherein the preset width is greater than that of the target information card and less than or equal to that of the information flow page; and display the detail information in the expanded target information card, wherein the length of the expanded target information card is set to be a length for completely displaying the detail information.

The computer program code for performing the operations of the present disclosure may be written in one or more programming languages or a combination thereof. The above-described programming languages include but are not limited to object-oriented programming languages, such as Java, Smalltalk, and C++, and also include conventional procedural programming languages, such as “C” language or similar programming languages. The program code may be executed entirely on of the user the computer, partly on of the user the computer, executed as an independent software package, partly on of the user the computer and partly executed on a remote computer, or entirely executed on the remote computer or server. In the case of a remote computer, the remote computer may be connected to of the user the computer through any kind of network (including a local area network (LAN) or a wide area network (WAN)), or may be connected to an external computer (for example, connected through Internet using an Internet service provider).

The flow charts and block views in the accompanying drawings illustrate the possibly implemented architectures, functions, and operations of the system, method, and computer program product according to various embodiments of the present disclosure. In this regard, each block in the flow chart or block view may represent a module, a program segment, or a part of code, wherein the module, the program segment, or the part of code contains one or more executable instructions for realizing a specified logic function. It should also be noted that, in some alternative implementations, the functions marked in the block may also occur in a different order from the order marked in the accompanying drawings. For example, two blocks shown in succession which may actually be executed substantially in parallel, may sometimes also be executed in a reverse order, depending on the functions involved. It should also be noted that each block in the block view and/or flow chart, and a combination of the blocks in the block view and/or flow chart, may be implemented by a dedicated hardware-based system that performs the specified functions or operations, or may be implemented by a combination of dedicated hardware and computer instructions.

The units involved in the described embodiments of the present disclosure may be implemented in software or hardware. Wherein, the names of the units do not constitute a limitation on the units themselves under certain circumstances.

The functions described hereinabove may be performed at least in part by one or more hardware logic components. For example, without limitation, the hardware logic components of a demonstrative type that may be used include: a Field Programmable Gate Array (FPGA), an Application Specific Integrated Circuit (ASIC), an Application Specific Standard Product (ASSP), a System on Chip (SOC), a Complex Programmable Logical device (CPLD) and the like.

In the context of the present disclosure, a machine-readable medium may be a tangible medium, which may contain or store a program for use by the instruction execution system, apparatus, or device or use in combination with the instruction execution system, apparatus, or device. The machine-readable medium may be a machine-readable signal medium or a machine-readable storage medium. The machine-readable medium may include, but is not limited to, an electronic, magnetic, optical, electromagnetic, infrared, or semiconductor system, device or device, or any suitable combination thereof. More specific examples of the machine-readable storage medium may include an electrical connection based on one or more wires, a portable computer disk, a hard disk, a random access memory (RAM), a read-only memory (ROM), an erasable programmable read-only memory (EPROM or flash memory), an optical fiber, a portable compact disk read-only memory (CD-ROM), an optical storage device, a magnetic storage device, or any suitable combination thereof.

The above description is only an explanation of preferred embodiments of the present disclosure and the applied technical principles. Those skilled in the art should understand that the scope of disclosure involved in this disclosure is not limited to the technical solutions formed by the specific combination of the above technical features, and at the same time should also cover other technical solutions formed by arbitrarily combining the above-described technical features or equivalent features without departing from the above disclosed concept. For example, the above-described features and the technical features disclosed in the present disclosure (but not limited thereto) having similar functions are replaced with each other to form a technical solution.

In addition, although the operations are depicted in a specific order, this should not be understood as requiring these operations to be performed in the specific order shown or performed in a sequential order. Under certain circumstances, multitasking and parallel processing might be advantageous. Likewise, although several specific implementation details are contained in the above discussion, these should not be construed as limiting the scope of the present disclosure. Certain features that are described in the context of individual embodiments may also be implemented in combination in a single embodiment. On the contrary, various features described in the context of a single embodiment may also be implemented in multiple embodiments individually or in any suitable sub-combination.

Although the present subject matter has been described in language specific to structural features and/or methodological actions, it should be understood that the subject matter defined in the appended claims is not necessarily limited to the specific features or actions described above. On the contrary, the specific features and actions described above are only exemplary forms of implementing the claims.

1. An information display method, comprising:
displaying at least two information cards on an information flow page;
obtaining detail information of a target information card of the at least two information cards in response to a triggering operation on the target information card, wherein a width of the target information card is less than a width of the information flow page, a preset width is greater than the width of the target information card and less than or equal to a width of the information flow page;
expanding the target information card on the information flow page and moving other information cards of the at least two information cards adjacent to the target information card until the width of the target information card is equal to the preset width; and
displaying the detail information in the expanded target information card, wherein a length of the expanded target information card is set to a length of a full displayed detail information.

2. The information display method according to claim 1, wherein the expanding the target information card on the information flow page comprises:
expanding the target information card on the information flow page based on an original position of the target information card.

3. The information display method according to claim 2, wherein:
the original position is determined based on an upper boundary and a target side boundary of the target information card, and the target side boundary is a side boundary of the target information card adjacent to a boundary of the information flow page; or
the original position is determined based on the upper boundary of the target information card.

4. The information display method according to claim 2, wherein the original position is a position of a center point of the target information card in the information flow page.

5. The information display method according to claim 1, wherein the expanding the target information card on the information flow page comprises:
moving the target information card to a preset position and expanding the target information card on the information flow page based on the preset position.

6. The information display method according to claim 5, wherein the preset position is a center position, a position of user's line of sight or a top position on the information flow page.

7. The information display method according to claim 1, further comprising:
displaying a floating function control for the detail information after displaying the detail information in the expanded target information card, wherein the floating function control comprises at least one of an interaction control or a fold up control.

8. The information display method according to claim 7, further comprising:
in response to a triggering operation on the fold up control, folding up the expanded target information card in an original size and original position on the information flow page and closing the floating function control.

9. The information display method-according to claim 1, further comprising:
after displaying the detail information in the expanded target information card, displaying the information flow page as a whole sliding longitudinally in response to a longitudinal sliding operation, the target information card sliding longitudinally with the information flow page.

10. The information display method according to claim 9, wherein:
a display position of a floating function control remains unchanged during a longitudinal sliding of the target information card; and
the floating function control is closed in response to a lower boundary of the target information card slides upwardly to a first predetermined position of the information flow page or an upper boundary of the target information card slides downwardly to a second predetermined position of the information flow page.

11. The information display method according to claim 1, wherein the detail information comprises a picture, and the information display method further comprises:
performing a resizing operation on the picture in response to a triggering operation on the picture, the resizing operation comprising zooming in or zooming out.

12. The information display method according to claim 11, further comprising:
displaying the picture in full-screen on the information flow page in response to a full-screen display operation on the picture.

13. The information display method according to claim 12, wherein the detail information comprises at least two pictures, and the information display method further comprises:
switching the picture to another picture in response to a sliding operation on the picture after displaying the picture in full screen on the information flow page.

14. The information display method according to claim 1, wherein the original information cards or the target information card comprises at least one of a video, a text, or an image.

15. (canceled)

16. An electronic device comprising:
a memory; and
a processor coupled to the memory, wherein the processor is configured to, based on instructions stored in the memory, carry out an information display method comprising;
displaying at least two information cards on an information flow page;
obtaining detail information of a target information card of the at least two information cards in response to a triggering operation on the target information card, wherein a width of the target information card is less than a width of the information flow page, a preset width is greater than the width of the target information card and less than or equal to a width of the information flow page;
expanding the target information card on the information flow page and moving other information cards of the at least two information cards adjacent to the target information card until the width of the target information card is equal to the preset width; and
displaying the detail information in the expanded target information card, wherein a length of the expanded target information card is set to a length of a full displayed detail information.

17. A non-transitory computer-readable storage medium, wherein the storage medium has a computer program stored thereon which is used to perform an information display method comprising:
displaying at least two information cards on an information flow page;
obtaining detail information of a target information card of the at least two information cards in response to a triggering operation on the target information card, wherein a width of the target information card is less than a width of the information flow page, a preset width is greater than the width of the target information card and less than or equal to a width of the information flow page;
expanding the target information card on the information flow page and moving other information cards of the at least two information cards adjacent to the target information card until the width of the target information card is equal to the preset width; and
displaying the detail information in the expanded target information card, wherein a length of the expanded target information card is set to a length of a full displayed detail information.

18. (canceled)

19. The electronic device according to claim 16, wherein the expanding the target information card on the information flow page comprises:
expanding the target information card on the information flow page based on an original position of the target information card.

20. The electronic device according to claim 19, wherein:
the original position is determined based on an upper boundary and a target side boundary of the target information card, and the target side boundary is a side boundary of the target information card adjacent to a boundary of the information flow page; or
the original position is determined based on the upper boundary of the target information card.

21. The electronic device according to claim 19, wherein the original position is a position of a center point of the target information card in the information flow page.

22. The electronic device according to claim 16, wherein the expanding the target information card on the information flow page comprises:
moving the target information card to a preset position and expanding the target information card on the information flow page based on the preset position.
